(19) United States
(12) Patent Application Publication
(10) Pub. No.: US 2014/0123015 A1
(43) Pub. Date: May 1, 2014

(54) INFORMATION PROCESSING SYSTEM, INFORMATION PROCESSING APPARATUS, AND STORAGE MEDIUM

(71) Applicant: SONY CORPORATION, Tokyo (JP)

(72) Inventors: Yoichiro SAKO, Tokyo (JP); Takatoshi NAKAMURA, Kanagawa (JP); Mitsuru TAKEHARA, Tokyo (JP); Yuki KOGA, Tokyo (JP); Kohei ASADA, Kanagawa (JP); Kazuyuki SAKODA, Chiba (JP); Kazuhiro WATANABE, Tokyo (JP); Yasunori KAMADA, Kanagawa (JP); Takayasu KON, Tokyo (JP); Kazunori HAYASHI, Tokyo (JP); Akira TANGE, Tokyo (JP); Hiroyuki HANAYA, Kanagawa (JP); Tomoya ONUMA, Shizuoka (JP)

(73) Assignee: SONY CORPORATION, Tokyo (JP)

(21) Appl. No.: 14/062,191

(22) Filed: Oct. 24, 2013

(30) Foreign Application Priority Data
Oct. 31, 2012 (JP) 2012240693

(51) Int. Cl. G06F 3/048

(52) U.S. Cl. CPC G06F 3/048
USPC 715/720

(57) ABSTRACT

There is provided an information processing system including a database in which at least one of a name, position information, and an image identifying a predetermined location is associated with specific content, a position identification part configured to identify a current position, a determination part configured to determine whether content corresponding to the current position is present in the database, a notification part configured to, when the determination part determines that the content corresponding to the current position is present, send to a user a notification that the content corresponding to the current position is present, and a controller configured to start playback of the content in accordance with an action of the user with respect to the notification by the notification part.

### CROSS REFERENCE TO RELATED APPLICATIONS

This application claims the benefit of Japanese Priority Patent Application JP 2012-240693 filed Oct. 31, 2012, the entire contents of which are incorporated herein by reference.

### BACKGROUND

The present disclosure relates to an information processing system, an information processing apparatus, and a storage medium.

In recent years, remarkable developments in technology of communication speed, storage capacity, display screen precision, and the like of mobile terminals have enabled users to easily download pieces of video content including movies and dramas to mobile terminals, and to view the pieces of video content. The following technology is disclosed, for example, as technology related to management of such pieces of video content.

For example, JP 2002-325241A suggests that high-definition and high sound quality data of a movie or a television program created by a professional is used by accumulating in a database movies and television programs that have already been on the screen and have already been broadcast. More specifically, the download system written in JP 2002-325241 A enables a user to access and download any part of audio data and moving image data of a video work, and the user can use the part for a standby screen, a ringtone melody, or the like of a communication terminal.

Further, JP 2007-528056T discloses technology for making scene content data to automatically contain link information related thereto. Further, JP 2007-528056T also describes that scene content data (shot image) is made to link with GPS position information (shooting location information).

### SUMMARY

However, neither JP 2002-325241A nor JP 2007-528056T particularly has a restriction on a location at which video content is viewed, and does not mention anything about providing a user with a world of a famous scene of video content in a link with the real world.

In light of the foregoing, it is desirable to provide in the present disclosure an information processing system, an information processing apparatus, and a storage medium, which are novel and improved, and are capable of notifying a user of content corresponding to a current position.

According to an embodiment of the present disclosure, there is provided an information processing system which includes a database in which at least one of a name, position information, and an image identifying a predetermined location is associated with specific content, a position identification part configured to identify a current position, a determination part configured to determine whether content corresponding to the current position is present in the database, a notification part configured to, when the determination part determines that the content corresponding to the current position is present, send to a user a notification that the content corresponding to the current position is present, and a controller configured to start playback of the content in accordance with an action of the user with respect to the notification by the notification part.

According to another embodiment of the present disclosure, there is provided an information processing apparatus which includes a position identification part configured to identify a current position, a notification part configured to, when a server determines that content corresponding to the current position is present in a database, send to a user a notification that the content corresponding to the current position is present, the server having the database in which at least one of a name, position information, and an image identifying a predetermined location is associated with specific content, and a controller configured to start playback of the content in accordance with an action of the user with respect to the notification by the notification part.

According to another embodiment of the present disclosure, there is provided a non-transitory computer-readable storage medium having a program stored therein, the program causing a computer to function as a position identification part configured to identify a current position, a notification part configured to, when a server determines that content corresponding to the current position is present in a database, send to a user a notification that the content corresponding to the current position is present, the server having the database in which at least one of a name, position information, and an image identifying a predetermined location is associated with specific content, and a controller configured to start playback of the content in accordance with an action of the user with respect to the notification by the notification part.

According to one or more of embodiments of the present disclosure described above, it becomes possible to notify a user of content corresponding to a current position.

### BRIEF DESCRIPTION OF THE DRAWINGS

FIG. 1 is a diagram illustrating an overview of a notification system according to an embodiment of the present disclosure;

FIG. 2 is a block diagram showing an internal configuration example of an HMD according to a first embodiment;

FIG. 3 is a block diagram showing a configuration of an operation controller according to the first embodiment;

FIG. 4 is a block diagram showing a configuration of a server according to the first embodiment;

FIG. 5 is a diagram showing an example of data stored in a content DB according to the first embodiment;

FIG. 6 is a flowchart showing notification processing performed by the HMD according to the first embodiment;

FIG. 7 is a flowchart showing processing of acquiring a list of relevant scenes according to the first embodiment;

FIG. 8 is a diagram showing a specific example of an AR-display according to the first embodiment;

FIG. 9 is a diagram illustrating a case of starting playback of a relevant scene by eye-controlled input;

FIG. 10 is a block diagram showing a configuration of an operation controller according to a second embodiment;

FIG. 11 is a flowchart showing notification processing performed by an HMD according to the second embodiment;

FIG. 12 is a flowchart showing priority order determination processing according to the second embodiment;

FIG. 13 is a diagram showing a specific example of an AR-display according to the second embodiment; and

FIG. 14 is a diagram illustrating a case of starting playback of a desired relevant scene by audio input.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Further, the description will be given in the following order.

1. Overview of notification system according to one embodiment of present disclosure

2. Embodiments
2-1. First embodiment
   2-1-1. Internal Configuration Example of HMD
   2-1-2. Configuration of server
   2-1-3. Notification processing
2-2. Second embodiment
   2-2-1. Configuration of operation controller
   2-2-2. Notification processing

3. Conclusion

### 1. Overview of Notification System According to One Embodiment of Present Disclosure

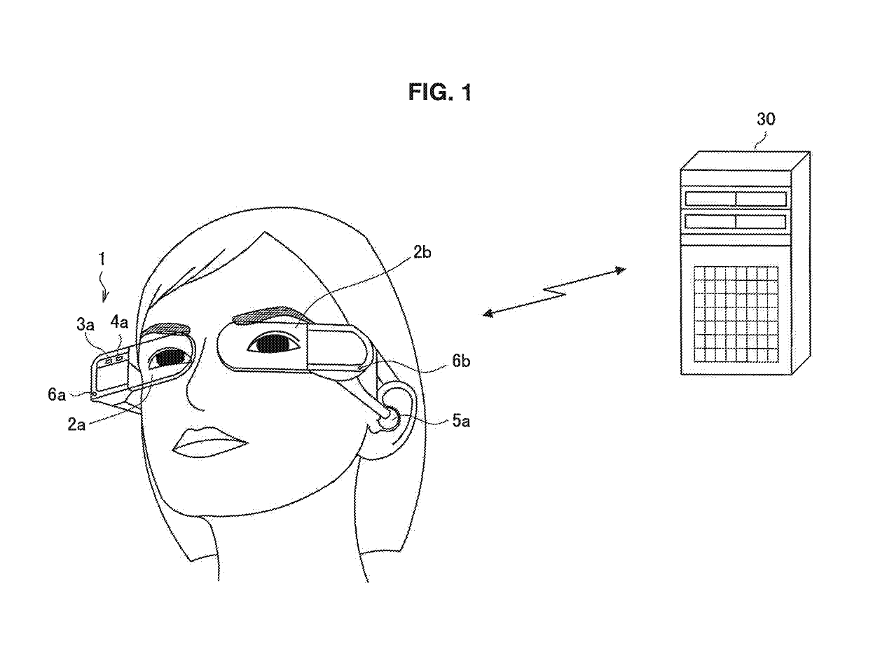

FIG. 1 is a diagram illustrating an overview of a notification system (information processing system) according to an embodiment of the present disclosure. As shown in FIG. 1, the notification system according to the present embodiment includes a head mounted display (HMD) 1 serving as an example of a user terminal, and a server 30.

The HMD shown in FIG. 1 is referred to as glasses-type display or see-through head mounted display (HMD). Specifically, for example, the HMD 1 includes a mounting unit having a structure of a frame that fits halfway around a head from both sides of the head to the back of the head, and is mounted on the user by the user wearing the HMD 1 on his/her conchae as shown in FIG. 1. Then, in the mounting state as shown in FIG. 1, the HMD 1 has a structure that a pair of display parts 2a and 2b for the right eye and the left eye are disposed at places immediately in front of both eyes of the user, that is, places where lenses of normal glasses are disposed. A liquid crystal panel is provided on each of the display parts 2 (display parts 2a and 2b), for example, and the HMD 1 can control the transmittance of the liquid crystal panels, and thus can make the liquid crystal panels to be in a see-through state as shown in FIG. 1, that is, in a transparent state or a semitransparent state. By making the display parts 2 to be in the see-through state, no inconvenience is caused to a normal life even if the user wears the HMD 1 all the time, just as the case where the user wears glasses.

In addition, the display parts 2 can overlay augmented reality (AR) information on real space scenery by displaying an image such as text or picture while the display parts 2 are in the transparent or semitransparent state.

Further, the display parts 2 can also display a captured image of a real space taken by an imaging lens 3a on the display parts 2, and overlay augmented reality (AR) information on the captured image of the real space. Further, the display parts 2 can also perform playback display of content received by the HMD 1 from an external device or content stored in a storage medium of the HMD 1. The external device includes, in addition to the server 30 shown in FIG. 1, an information processing apparatus such as a digital camera, a digital video camera, a mobile phone terminal, a smartphone, or a personal computer.

As the content to be played back on the display parts 2, there may be given moving image content such as a movie and a video clip, still image content that is imaged by a digital still camera or the like, and data of an electronic book, for example. Further, such content may include various types of data that are to be displayed, such as: data for computer-use including image data, text data, spread sheet data, and the like, which are created by a user on a personal computer or the like; and a game image based on a game program.

Further, the imaging lens 3a is disposed in a forward direction such that a subject is imaged taking, as a subject direction, a direction in which the user visually recognizes the subject in the state of wearing the HMD 1. Further, there is provided a light-emitting part 4a that illuminates in an imaging direction of the imaging lens 3a. The light-emitting part 4a is formed by a light emitting diode (LED), for example.

Further, although only the left ear side is shown in FIG. 1, there are provided a pair of earphone speakers 5a that can be inserted into the right earhole and the left earhole of the user in the mounted state.

Further, microphones 6a and 6b, which collect external sound, are placed on the right of the display part 2a for the right eye and on the left of the display part 2b for the left eye, respectively.

Note that the external appearance of the HMD 1 shown in FIG. 1 is an example, and there are various structures for a user to wear the HMD 1. Generally, the HMD 1 may be a mounting unit that is a glasses-type or a head mounted-type, and at least in the present embodiment, the display parts 2 may be provided in the proximity in a forward direction of the eyes of the user. Further, a pair of display parts 2 may be provided for the both eyes, and the HMD 1 may also have a structure that one display part may be provided for one of the eyes.

Further, the earphone speakers 5a may not be stereo speakers at right and left, and may be one earphone speaker 5a to be worn by one of the ears. Further, as a microphone, any one of the microphones 6a and 6b may be provided.

Further, there may be a structure in which the microphones 6a and 6b and the earphone speaker 5a are not included. Further, there may be a structure in which the light-emitting part 4a is not provided.

Here, as described above, neither JP 2002-325241A nor JP 2007-528056T particularly has a restriction on a location at which video content is viewed, and does not mention anything about providing a user with a world of a famous scene of video content in a link with the real world.

However, if it is possible to provide the user with a world of a famous scene of video content in a link with a location that the user is actually currently present (real world), the entertainment property of the video content increases.

Accordingly, a notification system according to each embodiment of the present disclosure has been created in view of the circumstances described above.

The notification system according to each embodiment of the present disclosure can identify a current position of the HMD 1, and can notify the user of content corresponding to the current position on the HMD 1. Further, the HMD 1 can also control playback of content in accordance with an action of the user with respect to the notification. In this way, the user can enjoy a famous scene of video content in a link with the real world.

Hereinafter, such embodiments of the present disclosure will be described sequentially. Note that, in the example shown in FIG. 1, although a glasses-type display (see-through HMD) is used as an example of a user terminal (information processing apparatus), the user terminal according to an embodiment of the present disclosure is not limited thereto. For example, the user terminal may be an HMD of other than the glasses-type, a digital camera, a digital video camera, a personal digital assistants (PDA), a personal computer (PC), a notebook PC, a tablet terminal, a mobile phone terminal, a smartphone, a mobile music playback device, a mobile video processing device, or a mobile game console.

### 2. Embodiments

### 2-1. First Embodiment

### 2-1-1. Internal Configuration Example of HMD

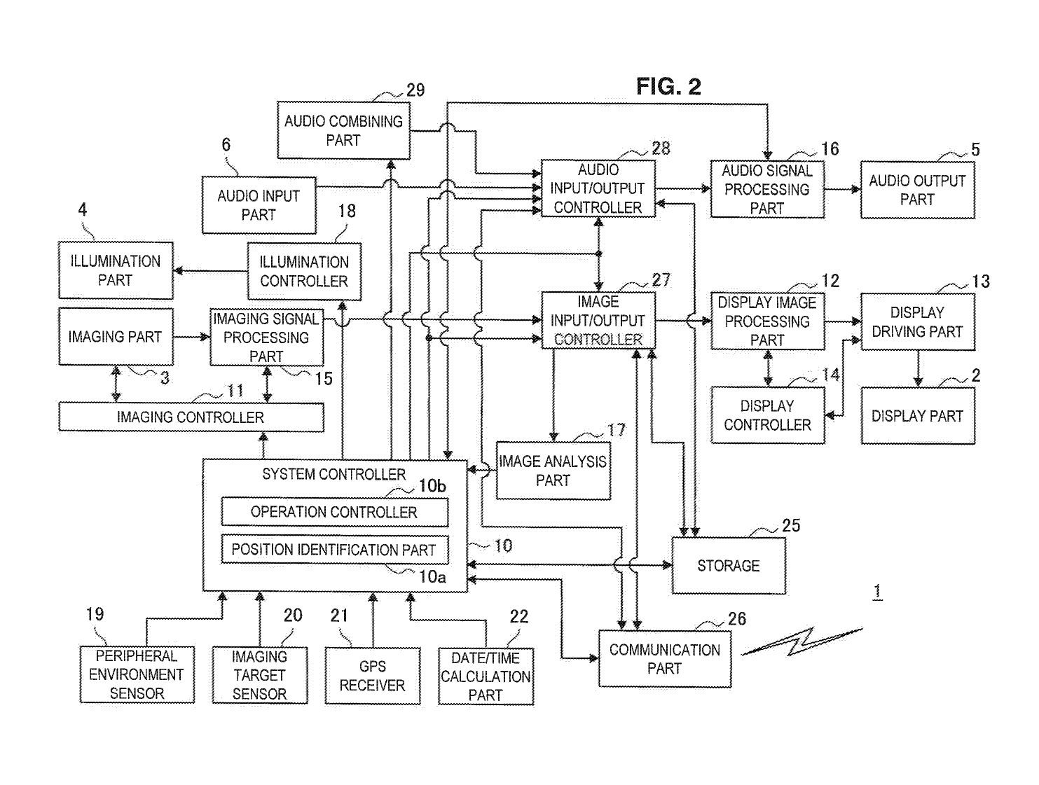

FIG. 2 is a block diagram showing an internal configuration example of an HMD 1 shown in FIG. 1. As shown in FIG. 2, the HMD 1 includes a display part 2, an imaging part 3, an illumination part 4, an audio output part 5, an audio input part 6, a system controller 10, an imaging controller 11, a display image processing part 12, a display driving part 13, a display controller 14, an imaging signal processing part 15, an audio signal processing part 16, an image analysis part 17, an illumination controller 18, a peripheral environment sensor 19, an imaging target sensor 20, a GPS receiver 21, a date/time calculation part 22, a storage 25, a communication part 26, an image input/output controller 27, an audio input/output controller 28, and an audio combining part 29.

(System Controller)

The system controller 10 is configured from a microcomputer including, for example, a central processing unit (CPU), read only memory (ROM), random access memory (RAM), non-volatile memory, and an interface part, and controls each structural element of the HMD 1.

Further, as shown in FIG. 2, the system controller 10 functions as a position identification part 10a that identifies a position of the HMD 1, and an operation controller 10b that controls operation of the HMD 1.

Position Identification Part

The position identification part 10a identifies a current position (current point) of the HMD 1 based on data output from the GPS receiver 21, the image analysis part 17, or the audio signal processing part 16. Specifically, for example, the position identification part 10a identifies, as the current position, current position information (such as latitude/longitude) received on a real-time basis from the GPS receiver 21. Further, the position identification part 10a may identify, as the current position, a captured image taken on a real-time basis by the imaging part 3 and analyzed by the image analysis part 17. Further, the position identification part 10a may also identify, as the current position, a name indicated by sound which is collected on a real-time basis by the audio input part 6 and processed by the audio signal processing part 16. Note that the name is an address, a name of a place, a name of a facility (including a name of a park), a name of a building, or the like.

Operation Controller

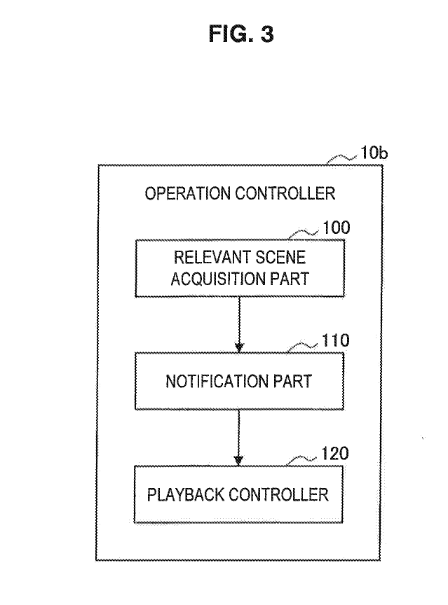

The operation controller 10b controls each operation of the HMD 1. Hereinafter, with reference to FIG. 3, functional configuration of the operation controller 10b will be described.

FIG. 3 is a block diagram showing a functional configuration of the operation controller 10b shown in FIG. 2. As shown in FIG. 3, the operation controller 10b functions as a relevant scene acquisition part 100, a notification part 110, and a playback controller 120.

The relevant scene acquisition part 100 acquires, from the server 30, content (relevant scene) corresponding to a current position of the HMD 1 identified by the position identification part 10a. The content corresponding to the current position includes: a moving image (video such as a movie, a drama, a commercial, or a music video) and a still image taken at the current position; and a video, animation, a novel and the like each having the current position as a place at which the work takes place (model). Further, the relevant scene acquisition part 100 may also acquire content corresponding to the current position from the server 30. In this case, the relevant scene acquisition part 100 may transmit the current position identified by the position identification part 10a to the server 30 and acquire a list of relevant scenes first, and then may download, from the server 30, a relevant scene to which a playback instruction is issued in the case where a playback command is input by a user.

In the case where it is determined by the server 30 that there is a relevant scene, the notification part 110 notifies the user that there is content corresponding to the current position. The case where it is determined by the server 30 that there is a relevant scene includes a case where a determination result indicating that there is a relevant scene is received from the server 30, or a case where a list of relevant scenes or data of a relevant scene is received from the server 30 by the relevant scene acquisition part 100. Further, examples of specific notification methods performed by the notification part 110 include screen display, audio, vibration, pressure, light-emission, and temperature change.

For example, the notification part 110 displays, on a part of the display part 2, one frame of the relevant scene, or a title or an opening screen of a video work including the relevant scene, and plays back, from the audio output part 5, main theme music of a video work including the relevant scene. Further, the notification part 110 may play back an alarm sound or a ringtone from the audio output part 5. Further, the notification part 110 may also vibrate the HMD 1 using a vibration part (not shown), and may apply pressure to a head of a user by bending a piezoelectric element (not shown) and deforming a frame part worn on the conchae.

Further, the notification part 110 may notify the user by flashing the display part 2, or an LED (not shown) or the light-emitting part 4a disposed on the HMD 1 such that the LED or the light-emitting part 4a is in a field of view of the user. Further, the notification part 110 may notify the user by controlling a heating/cooling material provided for the purpose of changing temperature of a part in contact with the user, such as a frame part of the HMD 1 worn on the conchae, and causing temperature to change.

The playback controller 120 starts playback of the relevant scene corresponding to the current position in accordance with an action of the user with respect to the notification by the notification part 110. Examples of the action of the user include eye-controlled input, audio input, gesture input, and button/switch operation.

The eye-controlled input may be detected by an imaging lens (not shown) disposed inside the HMD 1 such that the imaging lens images an eye of the user. The user can issue a playback instruction by winking or turning a line of sight to a thumbnail image or the like of the relevant scene shown on the display part 2. In detecting the line of sight using a camera, where the user gazes is identified by calculating the direction of the line of sight by tracking the motion of the pupil.

Further, the audio input may be detected by collecting sound by the audio input part 6 and recognizing the sound by the audio signal processing part 16. For example, the user can issue a playback instruction by uttering “start playback”, or the like.

Further, the gesture input may be detected by imaging a gesture of the user's hand by the imaging lens 3a and recognizing the gesture by the image analysis part 17. Alternatively, a gesture of the user's head may be detected by an acceleration sensor or a gyro sensor provided to the HMD 1.

Further, the button/switch operation may be detected by a physical button/switch (not shown) provided to the HMD 1. The user can issue a playback instruction by pressing a “confirm” button/switch.

(Imaging Part)

The imaging part 3 includes: a lens system including the imaging lens 3a, an aperture, a zoom lens, a focus lens, and the like; a drive system causing the lens system to perform a focusing operation and zooming operation; a solid-state image sensor array generating an imaging signal by performing photoelectric conversion of imaging light obtained in the lens system; and the like. The solid-state image sensor array may be a charge coupled device (CCD) sensor array or a complementary metal oxide semiconductor (CMOS) sensor array, for example. As shown in FIG. 1, since the imaging lens 3a is disposed in a forward direction such that a subject is imaged taking, as a subject direction, a direction in which the user visually recognizes the subject in the state of wearing the HMD 1, the imaging lens 3a can image a range including a range (field of view) that the user can see through the display part 2.

(Imaging Signal Processing Part)

The imaging signal processing part 15 includes a sample-hold/automatic gain control (AGC) circuit for subjecting a signal obtained by a solid-state image sensor in the imaging part 3 to gain adjustment and waveform shaping, and a video analog/digital (A/D) converter. By using those, the imaging signal processing part 15 obtains an imaging signal as digital data. In addition, the imaging signal processing part 15 also performs white balancing processing, brightness processing, color signal processing, blur correction processing, and the like on the imaging signal.

(Imaging Controller)

Based on an instruction issued from the system controller 10, the imaging controller 11 controls operations of the imaging part 3 and the imaging signal processing part 15. For example, the imaging controller 11 controls ON/OFF of the operations of the imaging part 3 and the imaging signal processing part 15. In addition, the imaging controller 11 executes control (motor control) for allowing the imaging part 3 to perform an operation such as autofocusing, automatic exposure adjustment, aperture adjustment, or zooming. The imaging controller 11 includes a timing generator, and uses a timing signal generated by the timing generator to control signal processing operations performed by the solid-state image sensor, and the sample-hold/AGC circuit and the video A/D converter in the imaging signal processing part 15. Further, such timing control enables adjustment of an imaging frame rate.

In addition, the imaging controller 11 controls imaging sensitivity and signal processing in the solid-state image sensor and the imaging signal processing part 15. For example, as control of the imaging sensitivity, the imaging controller 11 is capable of performing the gain control on the signal read from the solid-state image sensor, and capable of performing control of black level setting, control of various coefficients in processing the imaging signal in digital form, control of a correction value in the blur correction processing, and the like. Regarding the control of the imaging sensitivity, overall sensitivity adjustment with no regard to any particular wavelength range, and sensitivity adjustment of adjusting imaging sensitivity of a particular wavelength range such as an infrared range or an ultraviolet range (for example, imaging that involves cutting off the particular wavelength range) are possible, for example. Sensitivity adjustment in accordance with the wavelength is achieved by insertion of a wavelength filter in an imaging lens system or a wavelength filter operation process performed on the imaging signal. In these cases, the imaging controller 11 achieves the sensitivity control by controlling the insertion of the wavelength filter, specification of a filter operation coefficient, or the like.

(Image Input/Output Controller)

The imaging signal (image data obtained by imaging) obtained by imaging by the imaging part 3 and processing by the imaging signal processing part 15 is supplied to the image input/output controller 27. Under control of the system controller 10, the image input/output controller 27 controls transfer of the image data. That is, the image input/output controller 27 controls the transfer of the image data among the imaging system (imaging signal processing part 15), the display system (display image processing part 12), the storage 25, and the communication part 26.

For example, the image input/output controller 27 performs an operation of supplying image data as the imaging signal processed in the imaging signal processing part 15 to the display image processing part 12, to the storage 25, and to the communication part 26.

Further, the image input/output controller 27 performs an operation of supplying image data played back from the storage 25 to the display image processing part 12 and to the communication part 26, for example. Further, the image input/output controller 27 performs an operation of supplying the image data received by the communication part 26 to the display image processing part 12 and to the storage 25, for example.

(Display Image Processing Part)

The display image processing part 12 is what is called a video processor, and is a unit that can execute various types of display processes on the supplied image data. For example, the display image processing part 12 can perform, for example, the brightness level adjustment, the color correction, the contrast adjustment, and the sharpness (edge enhancement) adjustment, on the image data.

(Display Driving Part)

The display driving part 13 is formed by a pixel driving circuit for allowing image data supplied from the display image processing part 12 to be displayed on the display part 2, which is a liquid crystal display, for example. That is, the display driving part 13 applies driving signals based on a video signal to pixels arranged in a matrix in the display part 2 with specified horizontal/vertical driving timing, to thereby execute displaying. In addition, the display driving part 13 is capable of controlling transmittance of each of the pixels in the display part 2 to allow the pixel to enter the see-through state. Further, the display driving part 13 may make the display part 2 to be in the see-through state and may cause AR information to be displayed on a part of the display part 2.

(Display Controller)

The display controller 14 controls a processing operation of the display image processing part 12 and an operation of the display driving part 13 based on control of the system controller 10. Specifically, the display controller 14 controls the display image processing part 12 to perform the brightness level adjustment or the like on image data as described above. Further, the display controller 14 controls the display driving part 13 to perform switching between the see-through state and the image-displayed state of the display part 2.

(Audio Input Part)

The audio input part 6 includes the microphones 6a and 6b shown in FIG. 1, a microphone amplifier section for amplifying audio signals obtained by the microphones 6a and 6b, and an A/D converter, and outputs audio data to the audio input/output controller 28.

(Audio Input/Output Controller)

Under control of the system controller 10, the audio input/output controller 28 controls transfer of audio data. Specifically, the audio input/output controller 28 controls transfer of audio signals among the audio input part 6, the audio signal processing part 16, the storage 25, and the communication part 26. For example, the audio input/output controller 28 performs an operation of supplying the audio data obtained by the audio input part 6 to the audio signal processing part 16, to the storage 25, and to the communication part 26.

Further, the audio input/output controller 28 performs an operation of supplying audio data played back by the storage 25 to the audio signal processing part 16 and to the communication part 26, for example. Further, the audio input/output controller 28 performs an operation of supplying the audio data received by the communication part 26 to the audio signal processing part 16 and to the storage 25, for example.

(Audio Signal Processing Part)

The audio signal processing part 16 is formed by a digital signal processor, a D/A converter, and the like, for example. The audio signal processing part 16 is supplied with audio data obtained by the audio input part 6 and audio data from the storage 25 or the communication part 26 via the audio input/output controller 28. Under control of the system controller 10, the audio signal processing part 16 performs a process such as volume adjustment, tone adjustment, or application of a sound effect on the supplied audio data. Then, the audio signal processing part 16 converts the processed audio data into an analog signal, and supplies the analog signal to the audio output part 5. Note that the audio signal processing part 16 is not limited to a unit that performs digital signal processing, but may be a unit that performs signal processing using an analog amplifier, an analog filter, or the like.

(Audio Output Part)

The audio output part 5 includes the pair of earphone speakers 5a shown in FIG. 1 and an amplifier circuit for the earphone speakers 5a. Further, the audio output part 5 may be formed by a so-called bone conduction speaker. The audio output part 5 enables the user to listen to an external sound, audio played back by the storage 25, and audio received by the communication part 26.

(Storage)

The storage 25 is a unit for recording and playing back data onto or from a predetermined recording medium. The storage 25 is formed by a hard disk drive (HDD), for example. Needless to say, as the recording medium, various types of recording media are adoptable such as: solid-state memory such as flash memory; a memory card containing fixed memory; an optical disc; a magneto-optical disk; and hologram memory. The storage 25 may be such as to be capable of recording and playing back the data in accordance with the adopted recording medium.

Supplied to the storage 25 via the image input/output controller 27 are image data serving as an imaging signal which is imaged by the imaging part 3 and processed by the imaging signal processing part 15, and image data received by the communication part 26. Further, audio data obtained by the audio input part 6 and audio data received by the communication part 26 are supplied to the storage 25 via the audio input/output controller 28.

Under control of the system controller 10, the storage 25 encodes the supplied image data and audio data so that the data can be recorded on the recording medium, and records the encoded data on the recording medium. Further, under control of the system controller 10, the storage 25 plays back the image data and the audio data from the recording medium. The played back image data is output to the image input/output controller 27, and the played back audio data is output to the audio input/output controller 28.

(Communication Part)

The communication part 26 transmits and receives data to and from an external device. The communication part 26 is an example of a unit for acquiring outside world information. The communication part 26 may be configured to perform network communication via short-range wireless communication for a network access point, for example, in accordance with a system such as a wireless LAN, Bluetooth, or the like. Alternatively; the communication part 26 may perform wireless communication directly with the external device having a corresponding communication capability.

As the external device, various electronic devices each having an information processing function and a communication function are conceivable, such as a computer device, a PDA, a mobile phone terminal, a smartphone, a video device, an audio device, and a tuner device. Further, a terminal device and a server device which are connected to a network such as the Internet are also conceivable as the external device serving as a target of communication. In addition, a non-contact communication IC card having an IC chip embedded therein, a two-dimensional bar code such as a QR code (registered trademark), hologram memory, and the like may each be used as the external device, and the communication part 26 may be a unit that reads information from those external devices. In addition, another HMD 1 may be conceived as the external device.

Supplied to the communication part 26 via the image input/output controller 27 are image data serving as an imaging signal which is imaged by the imaging part 3 and processed by the imaging signal processing part 15, and image data played back by the storage 25. Further, audio data obtained by the audio input part 6 and audio data played back by the storage 25 are supplied to the communication part 26 via the audio input/output controller 28.

Under control of the system controller 10, the communication part 26 performs encoding processing, modulation processing, and the like for transmission on the supplied image data and audio data, and transmits the resultant data to the external device. Further, the communication part 26 performs an operation of receiving data from the external device. The received demodulated image data is output to the image input/output controller 27, and the received demodulated audio data is output to the audio input/output controller 28.

Further, data of a current position identified by the position identification part 10a is supplied to the communication part 26 according to the present embodiment, and the communication part 26 transmits the data of the current position to the server 30 serving as the external device, and inquires for content corresponding to the current position. Further, the communication part 26 receives the content corresponding to the current position from the server 30.

(Audio Combining Part)

Under control of the system controller 10, the audio combining part 29 performs audio combining, and outputs an audio signal. The audio signal output from the audio combining part 29 is supplied to the audio signal processing part 16 via the audio input/output controller 28 and is processed, and after that, the processed audio signal is supplied to the audio output part 5 and output in the form of audio for the user.

(Illumination Part, Illumination Controller)

The illumination part 4 includes the light-emitting part 4a shown in FIG. 1 and a light-emitting circuit for causing the light-emitting part 4a (for example, LED) to emit light. Under control of the system controller 10, the illumination controller 18 causes the illumination part 4 to execute a light-emitting operation. The light-emitting part 4a in the illumination part 4 for performing illumination in a forward direction is attached as shown in FIG. 1, and hence, the illumination part 4 performs the illumination operation in a direction of a field of view of the user.

(Peripheral Environment Sensor)

The peripheral environment sensor 19 is an example of a unit for acquiring outside world information. As the peripheral environment sensor 19, a light intensity sensor, a temperature sensor, a humidity sensor, a pressure sensor, and the like are specifically conceivable. The peripheral environment sensor 19 is a sensor for obtaining information for detecting brightness, temperature, humidity, or weather of the surroundings, as the peripheral environment of the HMD 1.

(Imaging Target Sensor)

The imaging target sensor 20 is an example of a unit for acquiring outside world information. Specifically, the imaging target sensor 20 is a sensor for detecting information related to an imaging target that is a subject of the imaging operation in the imaging part 3. For example, conceivable is a sensor for detecting information and energy of a particular wavelength of an infrared ray that the imaging target emits, such as an infrared sensor including a range sensor for detecting information of a distance from the HMD 1 to the imaging target, a pyroelectric sensor, or the like. In the case of the pyroelectric sensor, whether or not the imaging target is a living body such as a person or an animal can be detected, for example. In addition, also conceivable is a sensor for detecting information and energy of a particular wavelength of an ultraviolet ray that the imaging target emits, such as various types of ultraviolet (UV) sensors. In this case, whether or not the imaging target is a fluorescent material or a fluorescent substance can be detected, and an amount of ultraviolet rays of the outside world that is necessary for preventing sunburn can be detected, for example.

(GPS Receiver)

The GPS receiver 21 is an example of a unit for acquiring outside world information. Specifically, the GPS receiver 21 receives a radio wave from a global positioning system (GPS) satellite, and outputs information of a latitude/longitude as a current position.

(Date/Time Calculation Part)

The date/time calculation part 22 is an example of a unit for acquiring outside world information. The date/time calculation part 22 serves as a so-called clock part to calculate a date and time (year, month, day, hour, minute, second), and outputs information of the current date and time.

(Image Analysis Part)

The image analysis part 17 is an example of a unit for acquiring outside world information. Specifically, the image analysis part 17 analyzes image data, and obtains information of an image included in the image data. The image analysis part 17 is supplied with the image data via the image input/output controller 27. The image data to be a target of the image analysis in the image analysis part 17 is image data as a captured image obtained by the imaging part 3 and the imaging signal processing part 15, image data received by the communication part 26, or image data played back by the storage 25 from a recording medium.

Heretofore, the internal configuration of the HMD 1 according to the present embodiment has been described in detail. Note that, as a configuration for acquiring the outside world information, there are shown the peripheral environment sensor 19, the imaging target sensor 20, the GPS receiver 21, the date/time calculation part 22, the image analysis part 17, and the communication part 26, but it is not necessary that the HMD 1 include all of those. Further, another sensor may be provided such as an audio analysis part for detecting and analyzing the surrounding audio.

### 2-1-2. Configuration of Server

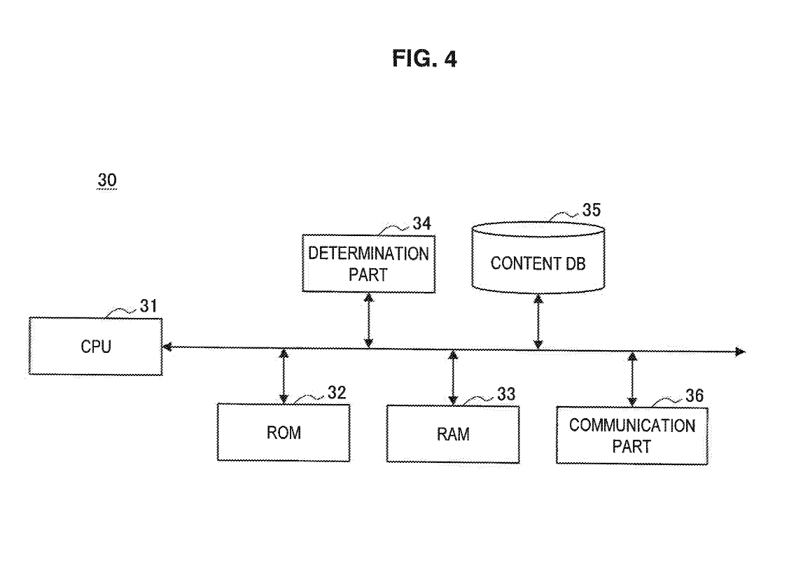

Next, with reference to FIG. 4, a configuration of the server 30 will be described. FIG. 4 is a block diagram showing a configuration of the server 30 according to the present embodiment. As shown in FIG. 4, the server 30 includes a central processing unit (CPU) 31, read only memory (ROM) 32, random access memory (RAM) 33, a determination part 34, a content DB 35, and a communication part 36.

(Content DB)

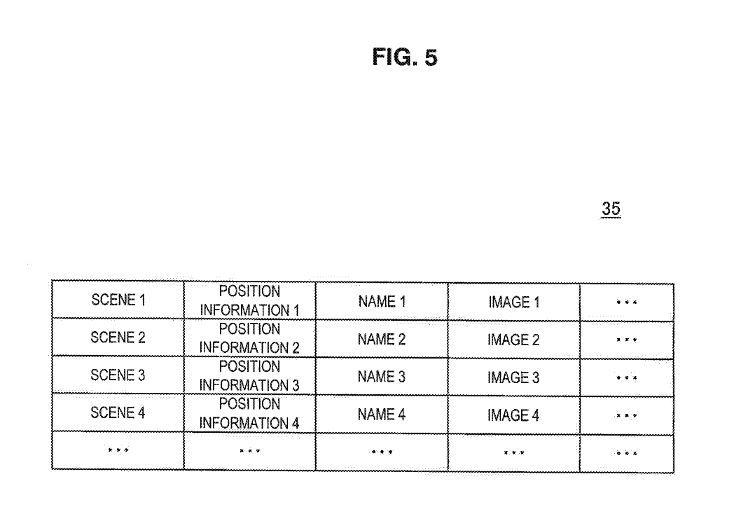

The content DB 35 is a database in which at least one of a name, position information, and an image identifying a predetermined location is associated with specific content. More specifically, specific video content, photograph content, text content, or the like is associated with a location at which the video or the photograph is taken or a location that the content has as a place at which the work takes place (model). Here, FIG. 5 shows an example of data stored in the content DB 35. As shown in FIG. 5, for example, famous scenes (scene 1 to scene 4) of various pieces of video content (movies, dramas, and the like) are associated with pieces of position information (position information 1 to position information 4) each identifying a location at which the scene is shot, names (name 1 to name 4), and images (image 1 to image 4). Note that the position information identifying a location is latitude/longitude information, for example. Further, the name identifying a location is an address, a name of a place, a name of a facility, or a name of a building, for example. Further, the image identifying a location is a captured image of the location, or a captured image of a distinctive building and scenery around the location.

In addition, each scene may be associated with a title of the video content including the scene, a title image, or main theme music.

(Determination Part)

The determination part 34 determines whether there is content corresponding to a current position transmitted from the HMD 1 in the content DB 35. Specifically, the determination part 34 compares latitude/longitude information indicating the current position, a captured image, a name, or the like transmitted by the HMD 1 with position information, an image, or a name indicating a specific location associated with each scene (video content) stored in the content DB 35. Then, in the case where the current position matches a specific location, the determination part 34 determines that there is the content corresponding to the current position of the HMD 1 in the content DB 35. The determination part 34 transmits the determination result from the communication part 36 to the HMD 1.

(Communication Part)

The communication part 36 is a communication module for transmitting and receiving data to and from the HMD 1. For example, the communication part 36 according to the present embodiment receives data of the current position from the HMD 1. Further, the communication part 36 transmits, to the HMD 1, the determination result obtained by the determination part 34 and the content corresponding to the current position of the HMD 1 extracted by the CPU 31 from the content DB 35.

(CPU, ROM, and RAM)

The CPU 10 is a controller which controls each structural element of the server 30. The CPU 10 controls each structural element in accordance with a software program stored in the ROM 11. More specifically, in the case where the determination part 34 determines that there is content corresponding to the current position in the content DB 35, the CPU 10 performs control in a manner that the relevant content (relevant scene) is extracted from the content DB 35 and is transmitted from the communication part 36 to the HMD 1, for example.

Further, the ROM 11 stores a software program and the like for the CPU 10 to execute each control. Further, the RAM 12 is used as a work area when the CPU 10 executes each control in accordance with a software program stored in the ROM 11.

### 2-1-3. Notification Processing

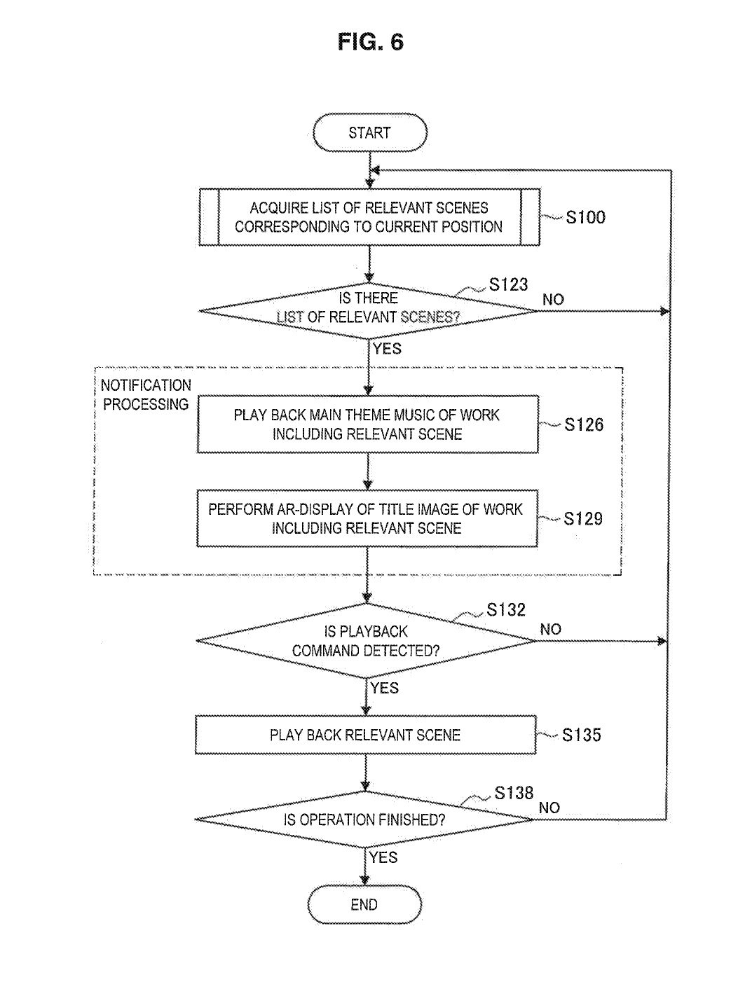

Subsequently, with reference to FIGS. 6 to 9, notification processing performed by the HMD 1 according to the present embodiment will be described. In the present embodiment, description will be given of operation processing in the ease of notifying a user of one piece of content corresponding to a current position and playing back the content in accordance with an action of the user.

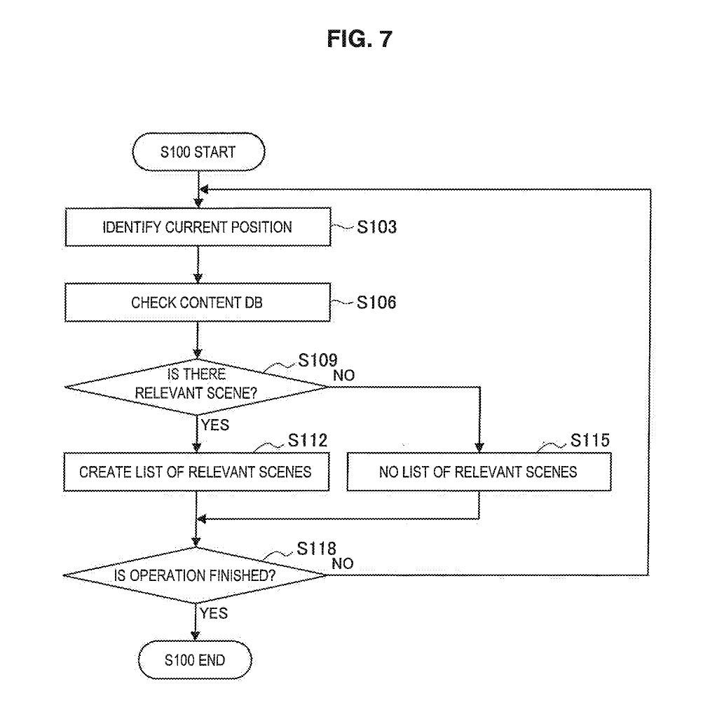

FIG. 6 is a flowchart showing notification processing performed by the HMD 1 according to the present embodiment. As shown in FIG. 6, first, in Step S100, the relevant scene acquisition part 100 of the HMD 1 acquires a list of relevant scenes corresponding to a current position from the server 30. The details of the processing are shown in FIG. 7. FIG. 7 is a flowchart showing processing of acquiring a list of relevant scenes according to the present embodiment.

As shown in FIG. 7, in Step S103, the position identification part 10a of the HMD 1 identifies the current position. Further, the HMD 1 transmits data of the identified current position to the server 30 and sends a request for a relevant scene corresponding to the current position.

Next, in Step S106, the determination part 34 of the server 30 checks the content DB 35 based on the data of the current position received from the HMD 1, and determines whether there is a relevant scene corresponding to the current position.

Next, in the case where the determination part 34 determines that there is a relevant scene (S109/YES), the CPU 31 creates a list of relevant scenes in Step S112. Specifically, the CPU 31 creates, as the list of relevant scenes, a list of thumbnail images of one or more relevant scenes or a list of title images of videos including one or more relevant scenes. Further, the CPU 31 transmits the created list of relevant scenes from the communication part 36 to the HMD 1.

On the other hand, in the case where the determination part 34 determines that there is no relevant scene (S109/NO), the CPU 31 may notify the HMD 1 that there is no list of relevant scenes in Step S115.

Then, in Step S118, the HMD 1 repeats the processing of S103 to S115 continuously until there is an of operation-finish instruction.

Heretofore, the processing of acquiring a list of relevant scenes corresponding to a current position has been described in detail. Note that, although the acquisition of the list of relevant scenes has been given as an example here, the relevant scene acquisition part 100 of the HMD 1 may also acquire, in addition to the list of relevant scenes, a determination result indicating that there is a relevant scene, or data itself of a relevant scene.

Next, in Step S123 of FIG. 6, the HMD 1 repeats the processing of S100 until the HMD 1 acquires the list of relevant scenes.

Next, in the case where the list of relevant scenes is acquired (S123/YES), the notification part 110 of the HMD 1 notifies a user that there is content (relevant scene) corresponding to the current position. Example of the method of notifying the user includes, as described above, notification using screen display, audio, vibration, or pressure. Here, as an example thereof, notification is performed by using audio and screen display. Specifically, in Step S126, the notification part 110 may play back main theme music of a work including a relevant scene at a low volume from the audio output part 5, for example. Accordingly, when the user wears the HMD 1, walks in a city, and passes a filming location of a drama, the user can hear a theme song of the drama from the audio output part 5 and can find that there is the drama filmed at the location at which the user is currently present.

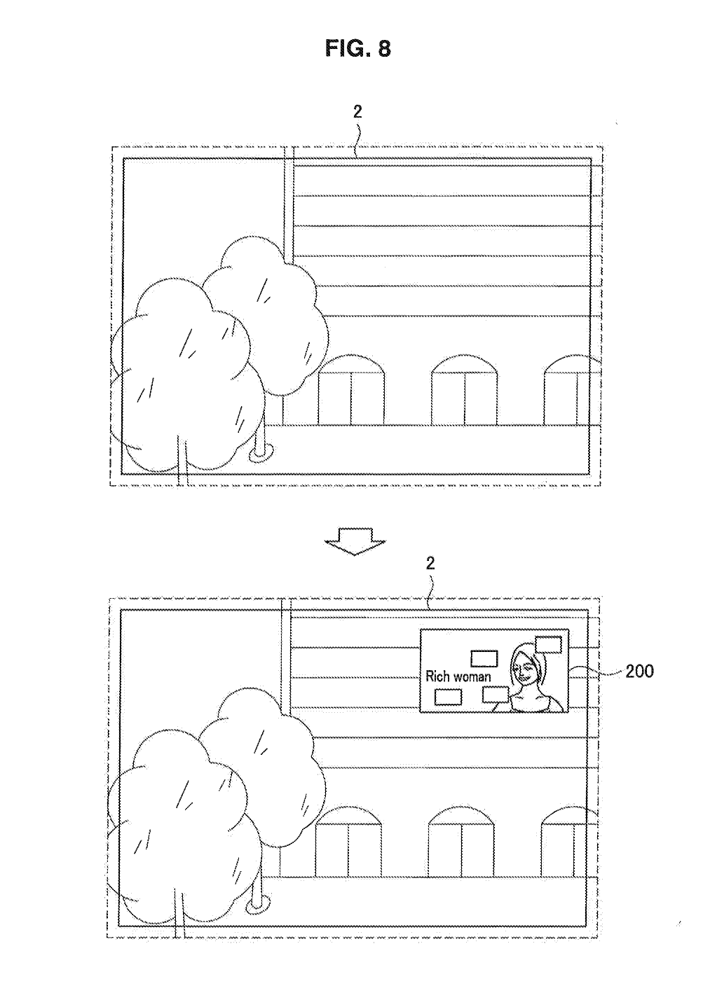

Next, in Step S129, the notification part 110 may notify the user by performing an AR-display in a manner that, for example, a thumbnail image of the relevant scene or a title image of a work including the relevant scene is overlaid on a real space at a part of the display part 2. Here, FIG. 8 shows a specific example of an AR-display according to the present embodiment. FIG. 8 shows a view that the user wearing the HMD 1 can see in a line-of-sight direction of the user. As shown in the top diagram of FIG. 8, in the case where the display part 2 of the HMD 1 is in the see-through state, since the user can see the view of the real space through the display part 2, the user can continuously wear the HMD 1 as the case of wearing glasses. As shown in the bottom diagram of FIG. 8, when the user moves with the HMD 1 worn and passes a filming location of a drama, a title image 200 of the drama whose filming location is the current point is subjected to the AR-display on the display part 2. In this way, the user finds that there is a drama filmed at the location at which the user is currently present.

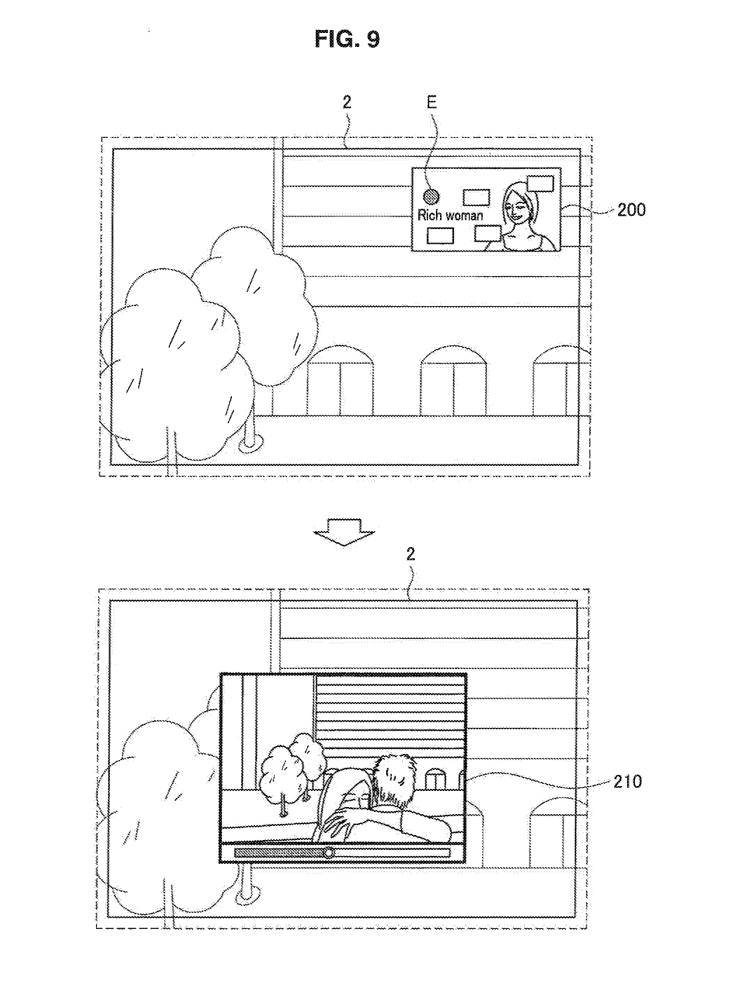

Next, in S132, the playback controller 120 of the HMD 1 accepts an action of the user with respect to the notification by the notification part 110, and detects a playback command (playback instruction). Examples of the action of the user include eye-controlled input, audio input, and button/switch operation. Here, with reference to FIG. 9, a case of playing back a relevant scene using the eye-controlled input, for example, will he described.

FIG. 9 is a diagram illustrating a case of starting playback of a relevant scene by eye-controlled input. The detection of the user's line of sight is performed using an imaging lens (not shown) disposed inside the HMD 1 such that the imaging lens images an eye of the user, as described above.

Then, as shown in the top diagram of FIG. 9, the HMD 1 displays, as a mark E, a result of detection of a user's line of sight on the display part 2. The user inputs a playback command by gazing the title image 200 of content corresponding to the current position displayed on the display part 2 for a predetermined time period. That is, in the case where the mark E, which is the result of detection of the line of sight, is laid on the title image 200, which is subjected to the AR-display on the display part 2, for the predetermined time period or more, the playback controller 120 of the HMD 1 detects that the playback command is issued.

Next, in the case where the playback command is detected (S132/YES), the playback controller 120 of the HMD 1 plays back the relevant scene corresponding to the current position in S135. For example, as shown in the bottom diagram of FIG. 9, the playback controller 120 performs control in a manner that one scene (moving image 210) of a drama filmed at the current position is played back on the display part 2. Further, the playback controller 120 may also play back the audio of the one scene at a high volume from the audio output part 5.

Then, in Step S138, the processing of S100 to S135 is repeated until there is an operation-finish instruction.

On the other hand, in the case where the playback command is not detected (S132/NO), the processing returns to Step S100. The case where the playback command is not detected represents the case where an action of the user is absent for a predetermined time period after the notification, or the case where a cancel command is detected. There are various cancel commands, for example, the cancel command may be a gesture of sweeping a hand in a forward direction, or a gesture of blowing off with the mouth (which may be detected using audio recognition, for example). In this case, the playback controller 120 does not play back the notified relevant scene. Further, the operation controller 10b may show animation in which the title image 200 of the relevant scene subjected to the AR-display by the notification part 110 is thrown far away in accordance with the cancel command, to thereby show clearly that the cancel command has been accepted.

Heretofore, notification processing according to the first embodiment has been described in detail. Note that, in the example shown in FIG. 9, the playback command is input using only the eye-controlled input, but the present embodiment is not limited thereto, and a combination of a plurality of operation input methods may be used, such as a combination of the eye-controlled input and a gesture or a button operation. For example, in the ease where the mark E, which is displayed as the result of detection of a user's line of sight, is laid on a desired title image 200 and there is a confirm instruction issued by a gesture or a button operation, the playback controller 120 may detect that the playback command is issued.

Further, in the example shown in FIG. 9, the title image 200 is subjected to the AR-display, and in addition, the notification part 110 may subject a title to a text display.

Further, even when the user is viewing a relevant scene, in the case where the user moves, a new current position is identified, and there is content corresponding to the new current position, the notification part 110 sends notification to the user. For example, the audio (main theme music or the like) of the relevant scene to be notified may be overlaid on audio of the relevant scene to be played back, and the display (title image or the like) of the relevant scene to be notified may be overlaid on the display of the relevant scene to be played back.

### 2-2. Second Embodiment

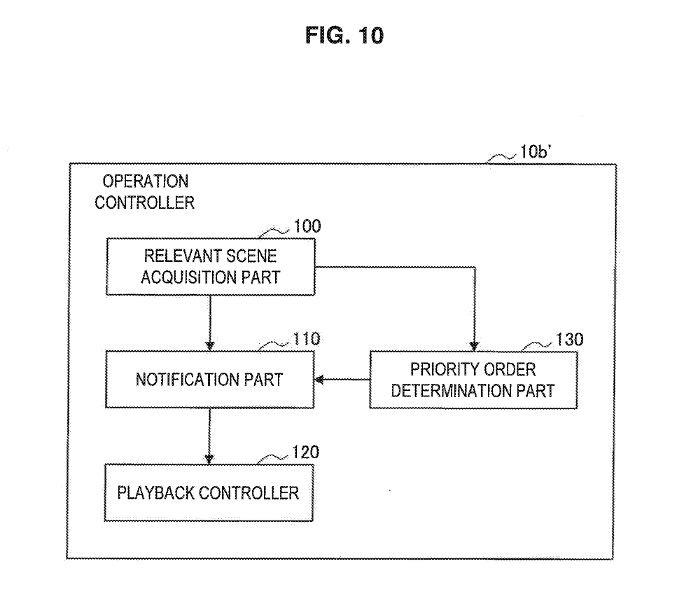

In the first embodiment described above, description has been made of the case of notifying a user of one piece of content corresponding to a current position. However, the present disclosure is not limited thereto, and can notify the user of a plurality of pieces of content, for example. Hereinafter, with reference to FIGS. 10 to 14, description will be given of operation processing in the case of notifying the user of a plurality of pieces of content, as a second embodiment.

### 2-2-1. Configuration of Operation Controller

A configuration of an HMD according to a second embodiment is the same as the configuration of the HMD 1 according to the first embodiment described with reference to FIG. 1 and FIG. 2, except that a system controller 10 has an operation controller 10b′. Hereinafter, with reference to FIG. 10, a configuration of the operation controller 10b′ according to the second embodiment will be described.

FIG. 10 is a diagram showing a configuration of the operation controller 10b′ according to the second embodiment. As shown in FIG. 10, the operation controller 10b′ includes a relevant scene acquisition part 100, a notification part 110, a playback controller 120, and a priority order determination part 130.

In the same manner as the first embodiment, the relevant scene acquisition part 100 acquires, from the server 30, a relevant scene which is content corresponding to a current position of the HMD 1 identified by the position identification part 10a. Further, the relevant scene acquisition part 100 outputs the acquired relevant scene to the notification part 110 and to the priority order determination part 130.

The priority order determination part 130 determines, in the case where there are a plurality of relevant scenes, priority order of the relevant scenes. Specifically, for example, the priority order determination part 130 may determine in advance the priority order starting from a relevant scene that matches a preference of a user based on preference information of the user stored in the storage 25. Alternatively, the priority order determination part 130 may also determine the priority order starting from a relevant scene which the user has not viewed yet based on a viewing history of the user.

Alternatively, the priority order determination part 130 may also determine the priority order starting from a relevant scene which the user has not viewed yet based on the preference information and the viewing history of the user. For example, the priority order determination part 130 may assign higher priority to a drama or a movie in which an actor whom the user likes appears and which the user has not viewed yet.

Then, the priority order determination part 130 outputs the data of the determined priority order to the notification part 110.

In the same manner as the first embodiment, in the case where it is determined by the server 30 that there is a relevant scene (including the case where the relevant scene is acquired by the relevant scene acquisition part 100), the notification part 110 notifies the user that there is content corresponding to the current position. Here, in the case where there are a plurality of relevant scenes, the notification part 110 may notify the user of the relevant scenes in order starting from a relevant scene having high priority in the priority order (having high priority order) in accordance with the priority order determined by the priority order determination part 130.

In the same manner as the first embodiment, the playback controller 120 starts playback of the relevant scene corresponding to the current position in accordance with an action of the user with respect to the notification by the notification part 110. Further, the playback controller 120 may also play back the plurality of relevant scenes corresponding to the current position in order starting from a relevant scene having high priority order in accordance with an action of the user.

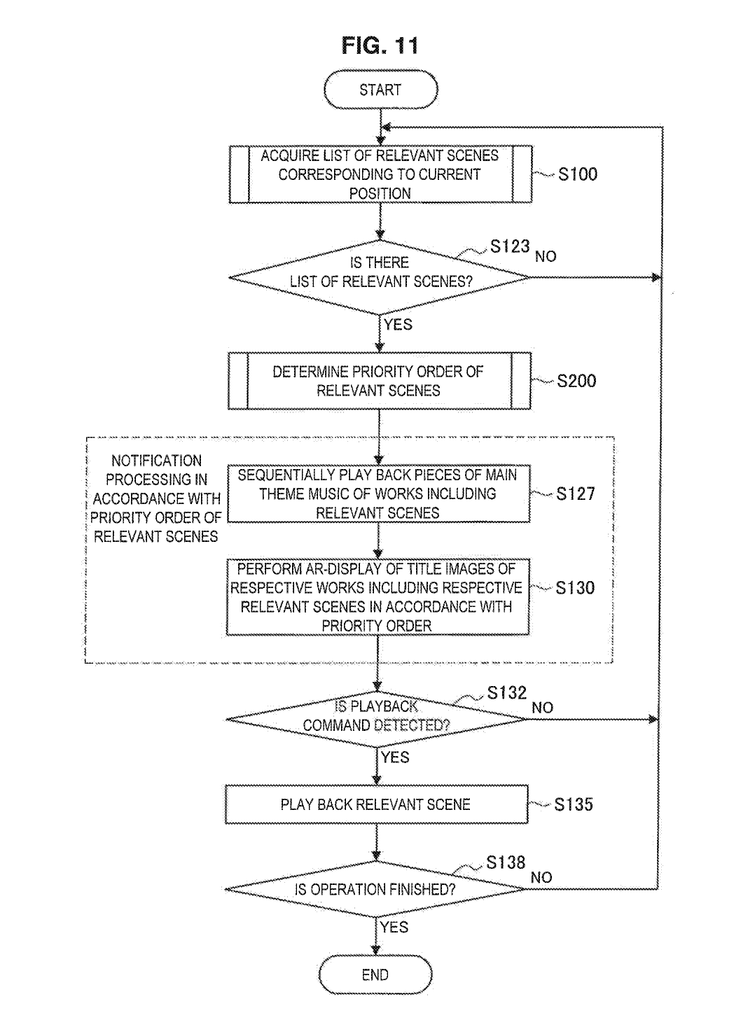

Heretofore, the operation controller 10b′ of the HMD 1 according to the present embodiment has been described in detail. Note that a server according to the present embodiment is the same as the server 30 according to the first embodiment that has been described with reference to FIG. 4. Subsequently, notification processing according to the second embodiment will be described with reference to FIGS. 11 to 14.

### 2-2-2. Notification Processing

FIG. 11 is a flowchart showing notification processing performed by the HMD 1 according to the second embodiment. As shown in FIG. 11, first, in Steps S100 and S123, the same processes as the processes of Steps S100 and S123 shown in FIG. 6 are performed.

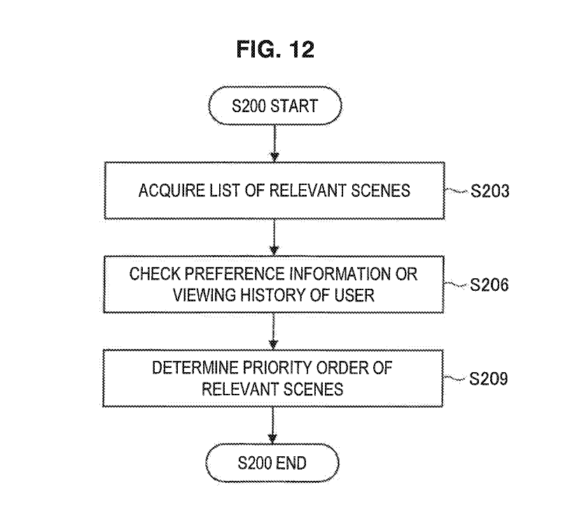

Next, in Step S200, the priority order determination part 130 of the HMD 1 determines priority order of relevant scenes. The detail of priority order determination processing is shown in FIG. 12. FIG. 12 is a flowchart showing priority order determination processing according to the present embodiment.

As shown in FIG. 12, in Step S203, the priority order determination part 130 of the HMD 1 acquires a list of relevant scenes from the relevant scene acquisition part 100.

Next, in Step S206, the priority order determination part 130 checks preference information or a viewing history of a user in order to determine the priority order of the relevant scenes included in the list. Note that the preference information and the viewing history of the user may be data stored in the storage 25 of the HMD 1 or data acquired from an external device.

Then, in Step S209, the priority order determination part 130 determines the priority order of the relevant scenes included in the list. Further, the priority order determination part 130 outputs data of the determined priority order to the notification part 110.

Next, in Steps S127 and S130 of FIG. 11, the notification part 110 of the HMD 1 notifies the user of the relevant scenes corresponding to the current position in accordance with the priority order. Specifically, in Step S127, the notification part 110 may sequentially play back pieces of main theme music of works including relevant scenes having high priority in the priority order at a low volume from the audio output part 5, for example.

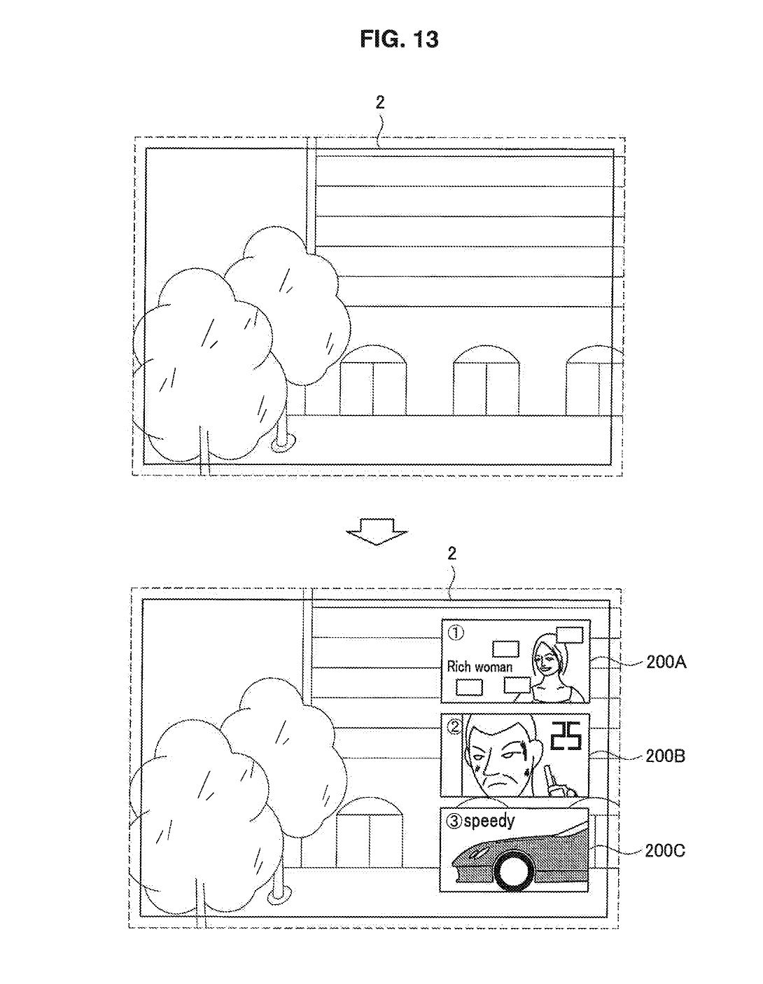

Further, in Step S130, the notification part 110 notifies the user by performing an AR-display in a manner that thumbnail images of the respective relevant scenes and title images of respective works including the relevant scenes are overlaid on a real space at a part of the display part 2. Here, FIG. 13 shows a specific example of an AR-display according to the present embodiment. FIG. 13 shows, in the same manner as FIG. 8 and FIG. 9, a view that the user wearing the HMD 1 can see in a line-of-sight direction of the user. As shown in the top diagram of FIG. 13, in the case where the display part 2 of the HMD 1 is in the see-through state, since the user can see the view of the real space through the display part 2, the user can continuously wear the HMD 1 as the case of wearing glasses. As shown in the bottom diagram of FIG. 13, when the user moves with the HMD 1 worn, title images 200A to 200C of dramas, movies, commercial messages (CM's), and the like whose filming location is the current point are subjected to the AR-display on the display part 2. In this way, the user finds that there are dramas, movies, CM's, and the like filmed at the location at which the user is currently present.

Note that, in this case, the notification part 110 notifies the user of a predetermined number of relevant scenes, the predetermined number being counted from the highest priority order, in accordance with the priority order of the relevant scenes determined by the priority order determination part 130. In the example shown in FIG. 13, the title images 200A to 200C of the top three relevant scenes are displayed.

Further, the notification part 110 may notify the user of a relevant scene having a next highest priority order automatically or when an instruction to send notification of the next relevant scene is issued by the user.

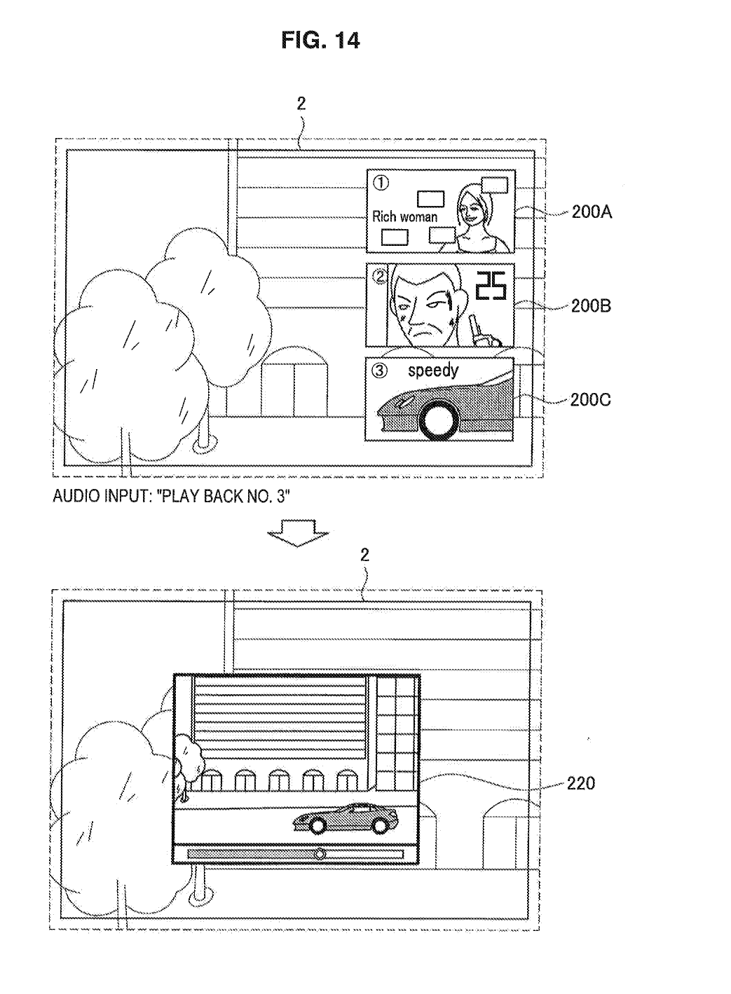

Subsequently; in Step S132, the playback controller 120 of the HMD 1 accepts an action of the user with respect to the notification by the notification part 110, and detects a playback command (playback instruction). Here, with reference to FIG. 14, a case of playing back a desired relevant scene using audio input, for example, will be described.

FIG. 14 is a diagram illustrating a case of starting playback of a desired relevant scene by audio input. The audio of the user is collected by the audio input part 6 of the HMD 1, is output to the audio signal processing part 16 via the audio input/output controller 28, and is processed by the audio signal processing part 16. Here, the audio signal processing part 16 can recognize the audio of the user and can detect the audio as a command.

Accordingly, as shown in the top diagram of FIG. 14, in the case where the display part 2 displays the title images 200A to 200C of the relevant scenes, the notification part 110 of the HMD 1 can input a playback command by the user uttering “play back No. 3”, for example. That is, in the case where the audio signal processing part 16 performs audio recognition of the audio of the user collected by the audio input part 6 and an instruction for playing back a specific relevant scene is recognized, the playback controller 120 of the HMD 1 detects that the playback command is issued.

Next, in the case where the playback command is detected (S132/YES), the playback controller 120 of the HMD 1 plays back the relevant scene corresponding to the current position in S135. For example, as shown in the bottom diagram of FIG. 14, the playback controller 120 performs control in a manner that a CM (moving image 220) of No. 3 (title image 200C) specified by the user, the CM being filmed at the current position, is played back on the display part 2. Further, the playback controller 120 may also play back the audio of the CM at a high volume from the audio output part 5.

Then, in Step S138, the processing of S100 to S135 is repeated until there is an operation-finish instruction.

On the other hand, in the case where the playback command is not detected (S132/NO), the processing returns to Step S100. The case where the playback command is not detected represents the case where an action of the user is absent for a predetermined time period after the notification, or the case where a cancel command is detected.

Heretofore, notification processing according to the second embodiment a been described in detail. Note that, in the case where the user utters “continuous playback” in S132 and the utterance is detected as the playback command, the playback controller 120 may sequentially and successively play back notified relevant scenes in accordance with the priority order in S135.

Further, although the case where the playback command is input using audio is described in the example shown in FIG. 14, the method of inputting the playback command by the user (action of the user) is not limited thereto, and as the example shown in FIG. 9, the playback command may be input by eye-controlled input. Further, in this case, in the case where the mark E, which is displayed as the result of detection of a users line of sight, is laid on a desired title image 200 and there is a confirm instruction issued by a gesture or a button operation, the playback controller 120 may detect that the playback command is issued.

### 3. Conclusion

As described above, a notification system (information processing system) according to the present embodiment checks a current position of the HMD 1 (user terminal) against content (moving image, still image, text, and the like) associated with a specific location, and thereby can perform notification of the content corresponding to the current position. Further, since the notification can provide the user with the location (real world) that the user is actually currently present in a link with a world of a famous scene of video content, the entertainment property of the video content increases.

It should be understood by those skilled in the art that various modifications, combinations, sub-combinations and alterations may occur depending on design requirements and other factors insofar as they are within the scope of the appended claims or the equivalents thereof.

For example, in the case where there is the specific location associated with the content of a famous scene in the vicinity, the HMD 1 of the present embodiment may lead a user in the direction of the specific location by performing an AR-display on the display part 2.

Further, in the case where a photograph of the real space is taken by the imaging lens 3a, the HMD 1 may inquire for content corresponding to the shot location (current position) from the server 30, and may notify the user of the content.

Further, the playback controller 120 may start playback of a relevant scene in accordance with an action of the user when the notification part 110 of the HMD I sends notification to the user by vibration, pressure, or the like. The playback controller 120 may also start playback of the relevant scene when the relevant scene is clearly shown and then a playback command is input. To clearly show the relevant scene means, for example, to display a title of a work of the relevant scene, and to play back main theme music of the work of the relevant scene.

Further, after the notification of the relevant scene or the playback of the relevant scene, the HMD 1 accesses a content distribution service or shows to the user an access to the content distribution service, and thus can promote the purchase of the work (video content and the like) of the relevant scene.

Further, the HMD 1 can also lead the user such that a field of view of the user gets closer to the angle of view of the relevant scene corresponding to the current position. Specifically, for example, the HMD 1 leads the user such that a field of view of the user gets closer to the angle of view of the relevant scene based on current position information (latitude/longitude/altitude) acquired by the GPS receiver 21, and based on a captured image taken by the imaging lens 3a in a user's line of sight, using audio or AR-display. The leading using the audio and the AR-display may include the leading indicating leading direction (forward/back, left/right, top/bottom), and in addition thereto, may include performing the AR-display of an outline of a main building or the like shown in the relevant scene on the display part 2. The user moves by himself/herself in a manner that the AR-display of the outline on the display part 2 matches the outline of the target building in the real space, and thus the field of view of the user can get closer to the angle of view of the relevant scene.

Further, since the HMD 1 can identify a current position not only by a captured image, but also by position information, a name, and the like, the HMD 1 can also notify the user of a famous scene of a movie or a drama that has been filmed in the past in the streetscapes that have disappeared or changed at the present time.

Further, each embodiment described above notifies the user of content (video, photograph, text) shot at the current position or content having the current position as a place at which the work takes place as the content corresponding to the current position, but the notification processing according to each embodiment of the present disclosure is not limited thereto. For example, in the case where there is content to be imaged at the current position, the HMD 1 may notify the user of the content (title or the like).

Further, in each embodiment described above, description has been given of the notification system including the HMD 1 and the server 30, but the notification system according to each embodiment of the present disclosure is not limited thereto, and the HMD 1 may further include a main configuration of the server 30 and may execute the notification system according to each embodiment of the present disclosure. That is, if the HMD 1 further includes the determination part 34 and the content DR 35, the HMD 1 can perform notification processing of content corresponding to the current position without acquiring content from an external device in particular.

Additionally, the present technology may also be configured as below.
(1) An information processing system including:

a database in which at least one of a name, position information, and an image identifying a predetermined location is associated with specific content;

a position identification part configured to identify a current position;

a determination part configured to determine whether content corresponding to the current position is present in the database;

a notification part configured to, when the determination part determines that the content corresponding to the current position is present, send to a user a notification that the content corresponding to the current position is present; and

a controller configured to start playback of the content in accordance with an action of the user with respect to the notification by the notification part.
(2) The information processing system according to (1),

wherein the controller causes at least one scene of the content associated with the current position to be played back.
(3) The information processing system according to (1) or (2),

wherein the controller causes a plurality of scenes of the content associated with the current position to be played back successively.
(4) The information processing system according to any one of (1) to (3),

wherein, based on at least one of a viewing history and preference information of the user, the controller assigns a priority order to each of a plurality of scenes, and causes the scenes to be played back sequentially from a scene having a high priority.
(5) The information processing system according to any one of (1) to (4),

wherein, even when the content is being played back by the controller, in a case where content corresponding to a new current position identified by the position identification part is present, the notification part send to the user a notification that the content corresponding to the new current position is present.
(6) The information processing system according to any one of (1) to (5),

wherein the content is one of a moving image, a still image, or a text.
(7) The information processing system according to any one of (1) to (6),

wherein the position identification part identifies a current position based on at least one of a name, position information, and an image of a current point.
(8) The information processing system according to (7),

wherein the name is one of an address, a name of a place, a name of a facility, and a name of a building.
(9) The information processing system according to (7),

wherein the position information is measured using a global positioning system (GPS).
(10) The information processing system according to (7),

wherein the image is a captured image taken by an imaging part.
(11) The information processing system according to any one of (1) to (10),

where the notification part sends a notification by one of screen display, audio, vibration, pressure, light-emission, and temperature change.
(12) The information processing system according to any one of (1) to (11),

wherein the action of the user with respect to the notification is one of eye-controlled input, audio input, gesture input, and button/switch operation.
(13) The information processing system according to any one of (1) to (12), further including:

a server; and

a user terminal,

wherein the server has the database and the determination part, and

wherein the user terminal has the position identification part, the notification part, and the controller.
(14) The information processing system according to (13),

wherein the user terminal is one of a mobile phone terminal, a smartphone, a mobile game console, a tablet terminal, a personal digital assistant (PDA), a notebook computer, a digital camera, and a digital video camera.
(15) The information processing system according to (13),

wherein the user terminal is one of a head mounted display and a glasses-type display.
(16) An information processing apparatus including:

a position identification part configured to identify a current position;

a notification part configured to, when a server determines that content corresponding to the current position is present in a database, send to a user a notification that the content corresponding to the current position is present, the server having the database in which at least one of a name, position information, and an image identifying a predetermined location is associated with specific content; and

a controller configured to start playback of the content in accordance with an action of the user with respect to the notification by the notification part.
(17) A non-transitory computer-readable storage medium having a program stored therein, the program causing a computer to function as

a position identification part configured to identify a current position,

a notification part configured to, when a server determines that content corresponding to the current position is present in a database, send to a user a notification that the content corresponding to the current position is present, the server having the database in which at least one of a name, position information, and an image identifying a predetermined location is associated with specific content, and

a controller configured to start playback of the content in accordance with an action of the user with respect to the notification by the notification part.

What is claimed is:

1. An information processing system comprising:
a database in which at least one of a name, position information, and an image identifying a predetermined location is associated with specific content;
a position identification part configured to identify a current position;
a determination part configured to determine whether content corresponding to the current position is present in the database;
a notification part configured to, when the determination part determines that the content corresponding to the current position is present, send to a user a notification that the content corresponding to the current position is present; and
a controller configured to start playback of the content in accordance with an action of the user with respect to the notification by the notification part.

2. The information processing system according to claim 1,
wherein the controller causes at least one scene of the content associated with the current position to be played back.

3. The information processing system according to claim 1,
wherein the controller causes a plurality of scenes of the content associated with the current position to be played back successively.

4. The information processing system according to claim 1,
wherein, based on at least one of a viewing history and preference information of the user, the controller assigns a priority order to each of a plurality of scenes, and causes the scenes to be played back sequentially from a scene having a high priority.

5. The information processing system according to claim 1,
wherein, even when the content is being played back by the controller, in a case where content corresponding to a new current position identified by the position identification part is present, the notification part send to the user a notification that the content corresponding to the new current position is present.

6. The information processing system according to claim 1,
wherein the content is one of a moving image, a still image, or a text.

7. The information processing system according to claim 1,
wherein the position identification part identifies a current position based on at least one of a name, position information, and an image of a current point.

8. The information processing system according to claim 7,
wherein the name is one of an address, a name of a place, a name of a facility, and a name of a building.

9. The information processing system according to claim 7,
wherein the position information is measured using a global positioning system (GPS).

10. The information processing system according to claim 7,
wherein the image is a captured image taken by an imaging part.

11. The information processing system according to claim 1,
wherein the notification part sends a notification by one of screen display, audio, vibration, pressure, light-emission, and temperature change.

12. The information processing system according to claim 1,
wherein the action of the user with respect to the notification is one of eye-controlled input, audio input, gesture input, and button/switch operation.

13. The information processing system according to claim 1, further comprising;
a server; and
a user terminal,
wherein the server has the database and the determination part, and
wherein the user terminal has the position identification part, the notification part, and the controller.

14. The information processing system according to claim 13,
wherein the user terminal is one of a mobile phone terminal, a smartphone, a mobile game console, a tablet terminal, a personal digital assistant (PDA), a notebook computer, a digital camera, and a digital video camera.

15. The information processing system according to claim 13,
wherein the user terminal is one of a head mounted display and a glasses-type display.

16. An information processing apparatus comprising:
a position identification part configured to identify a current position;
a notification part configured to, when a server determines that content corresponding to the current position is present in a database, send to a user a notification that the content corresponding to the current position is present, the server having the database in which at least one of a name, position information, and an image identifying a predetermined location is associated with specific content; and
a controller configured to start playback of the content in accordance with an action of the user with respect to the notification by the notification part.

17. A non-transitory computer-readable storage medium having a program stored therein, the program causing a computer to function as
a position identification part configured to identify a current position,
a notification part configured to, when a server determines that content corresponding to the current position is present in a database, send to a user a notification that the content corresponding to the current position is present, the server having the database in which at least one of a name, position information, and an image identifying a predetermined location is associated with specific content, and
a controller configured to start playback of the content in accordance with an action of the user with respect to the notification by the notification part.
